(19) United States
(12) Patent Application Publication
(10) Pub. No.: US 2012/0237918 A1
(43) Pub. Date: Sep. 20, 2012

(54) INFORMATION DISPLAY APPARATUS AND QUESTION INPUTTING APPARATUS, AND DISPLAY SYSTEM

(76) Inventor: Yukiko KAIDA, Tokyo (JP)

(21) Appl. No.: 13/358,012

(22) Filed: Jan. 25, 2012

(30) Foreign Application Priority Data
Mar. 18, 2011 (JP) 2011-061543
Nov. 10, 2011 (JP) 2011-246908

(51) Int. Cl. G09B 7/00

(52) U.S. Cl. 434/362

(57) ABSTRACT

An information display apparatus, including: a question management unit that adds identification management information to question information, the question information including (1) a question which is asked with designating an image displayed by the display unit and (2) a question target page; a question image generating unit that generates a question image based on the question information; an operation unit that accepts requests from an external source; a page management unit that determines an order of the question target page for displaying based on the identification management information and that composes the display image with the question image to generate a composed image based on the determined order; and a display unit that displays the composed image.

### CROSS-REFERENCE TO RELATED APPLICATIONS

The present application claims priority to and incorporates by reference the entire contents of Japanese Patent Application No. 2011-061543 filed in Japan on Mar. 18, 2011 and Japanese Patent Application No. 2011-246908 filed in Japan on Nov. 10, 2011.

### BACKGROUND OF THE INVENTION

1. Field of the Invention

The present invention relates to an apparatus, method, and system of display of information, to an information display apparatus, and a question inputting apparatus.

2. Description of the Related Art

Conventionally, a briefing material or presentation is handed out to each participant ahead of a lecture, a briefing session, or a meeting held in an office or a college. The briefing material which is made on and stored in a personal computer (PC) is projected onto a screen with a projector that projects information. Conventionally the projector connects to the PC through a wired network or a wireless network, and materials are printed through the PC.

A questioner often asks a question to the briefer by designating a page, after a presentation the briefer presented with reference to the briefing material including a plurality of pages by using the projector. However, in this case, the briefer needs to operate the PC to find and show the page corresponding to the question, which can take a lot of time, effort, and trouble.

Certain background arts have tried to address this situation. For example, Japanese Patent Application Laid-open No. 2010-146116 discloses an art by which the questioner designates the page corresponding to the question and sends the question to a server from a terminal, and the server stores material correlated with the question. In that art, during the question and answer period, contents of the material and questions are shown at the same time by displaying a question showing area in addition to a content showing area.

### SUMMARY OF THE INVENTION

The background art stated above, however, can not control an order of showing questions because in the case of displaying the question showing area in addition to the content showing area, all questions corresponding to the page are shown on the one page. It then becomes difficult to see the content of the material because the content showing area becomes small. The briefer then may not be able to recognize a portion of the page of the material corresponding to the question, and it may become difficult for the briefer to answer the question. These problems make the meeting less efficient.

The present invention can address the above and other problems. One object of the present invention is to provide an information projection apparatus and a question inputting apparatus that makes a presenter better able to control the order of showing questions during a question and answer period.

According to one aspect of the present invention, an information display apparatus includes: a question management unit that adds identification management information to question information including a question which is asked with designating an image displayed by the display unit and a question target page; a question image generating unit that generates a question image based on the question information; an operation unit that accepts requests from an external source; a page management unit that determines an order of the question target page for displaying based on the identification management information and that composes the display image with the question image to generate a composed image based on the order; and a display unit that displays the composed image.

According to other aspects of the present invention, it is possible to provide in the information display apparatus a control that makes the briefer better able to control an order of questions based on question information by the questioners.

### BRIEF DESCRIPTION OF THE DRAWINGS

FIG. 1 is a diagram illustrating a system configuration of an information projection system;

FIG. 2 is a block diagram of an information projection apparatus and a question inputting apparatus;

FIG. 3 is a sequence diagram illustrating a process of registering question information;

FIG. 4 is a diagram illustrating one example of an input for generating question information;

FIG. 5 is a diagram illustrating one example of the question information;

FIG. 6 is a diagram illustrating a data structure of the question information;

FIGS. 7(a)-7(c) are diagrams illustrating examples of the question information;

FIG. 8 is a sequence diagram illustrating a process of composing a question image with a display image;

FIG. 9 is a flowchart diagram illustrating a process of designating the question information intended to be displayed;

FIG. 10 is a diagram illustrating one example of the question information;

FIG. 11 is a diagram illustrating one example of the question information;

FIGS. 12(a), 12(b) are diagrams illustrating a process of generating the question image;

FIG. 13 is a flowchart diagram illustrating a process of composing a question image with a display image;

FIG. 14 is a diagram illustrating a display image during a presentation and a diagram illustrating a display image after the presentation;

FIG. 15 is a diagram illustrating an example of a composite image displayed after the presentation;

FIG. 16 is a diagram illustrating an example of a composite image displayed after the presentation;

FIG. 17 is a diagram illustrating an example of a composite image displayed after the presentation;

FIG. 18 is a diagram illustrating an example of a composite image displayed after the presentation;

FIG. 19 is a diagram illustrating an example of a composite image displayed after the presentation;

FIG. 20 is a diagram illustrating an example of a composite image displayed after the presentation;

FIG. 21 is a diagram illustrating an example of a composite image displayed after the presentation;

FIG. 22 is a diagram illustrating an example of a composite image displayed after the presentation;

FIG. 23 is a block diagram of an information projection apparatus;

FIG. 24 is a diagram illustrating a system configuration of an information projection system according to another embodiment;

FIG. 25 is a diagram illustrating a system configuration of an information projection system according to another embodiment; and

FIG. 26 is a diagram illustrating a system configuration of an information projection system according to another embodiment.

### DETAILED DESCRIPTION OF PREFERRED EMBODIMENTS

Hereinafter, exemplary embodiments of the present invention will be described with reference to the accompanying drawings. But, the present invention is not limited to the embodiments, and variations and modifications may be made without departing from the basic concepts of the present invention as claimed.

Further, hereinafter, an information projection apparatus that projects images on a screen will be described as an example of an information display apparatus. The information display apparatus is not, however, limited to an information projection apparatus, but can also include a display device and so on.

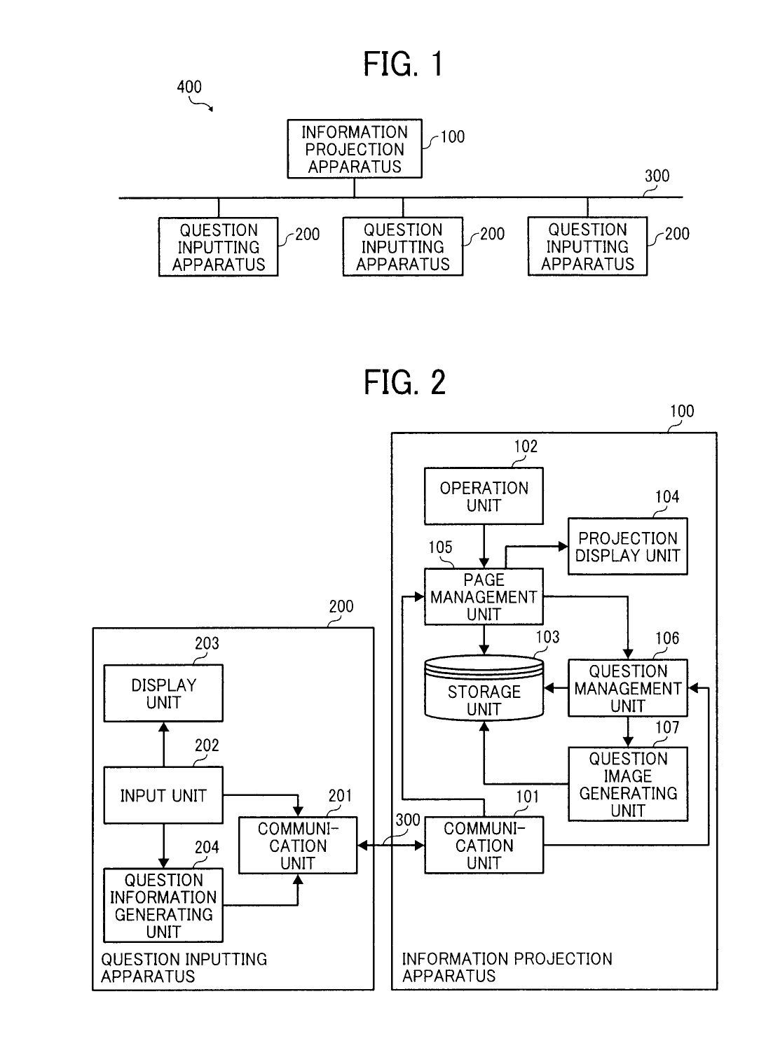

FIG. 1 is a diagram illustrating a system configuration of an information projection system 400. FIG. 2 is a block diagram of an information projection apparatus 100 and a question inputting apparatus 200. The information projection system 400 according to this embodiment includes the information projection apparatus 100 and a plurality of question inputting apparatuses 200 such as personal computers (PC), which are mutually connected to each other by a communication network 300 (for example, Internet, local area network (LAN)).

Further, the information projection apparatus 100 includes a projector that projects content of document data on a projection screen, but it is not limited to a projector.

Firstly, the question inputting apparatus 200 will be described. As illustrated in FIG. 2, the question inputting apparatus 200 includes a communication unit 201, an input unit 202, a display unit 203, and a question information generating unit 204.

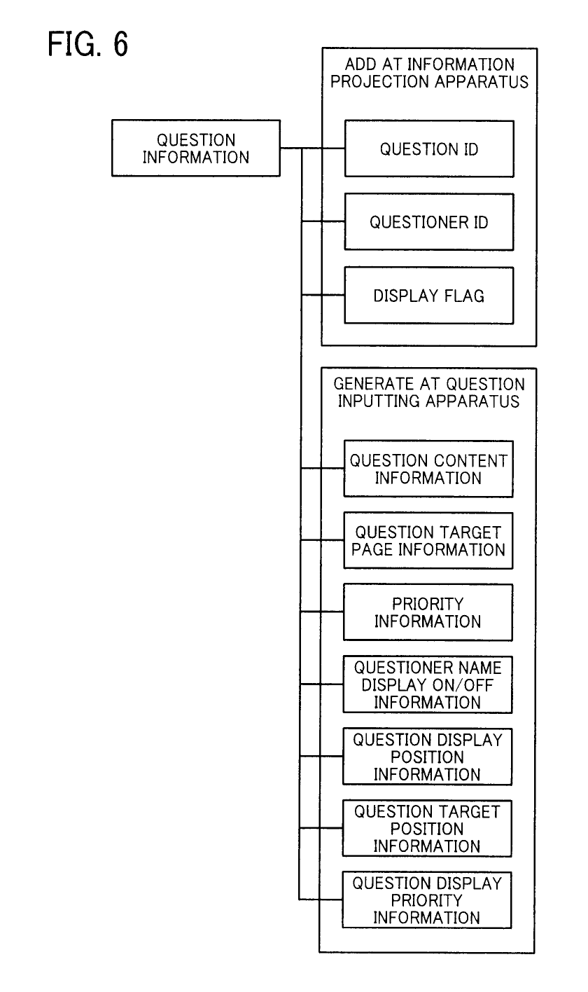

The communication unit 201 sends and receives various information and requests with the information projection apparatus 100. For example, the communication unit 201 sends question information (for example illustrated in FIG. 6) to the information projection apparatus 100.

The display unit 203 refers to the display image stored in a storage unit 103 of the information projection apparatus 100 through the communication unit 201, and displays the display image.

The input unit 202 accepts an input to the screen displayed on the display unit 203. For example, the input unit 202 accepts an input for designating a question display position and a question target position to the screen displayed on the display unit 203. Further, the input unit 202 accepts question content described with text to the screen displayed on the display unit 203.

The question information generating unit 204 generates the question information based on the question content information, the question target position, and the question display position input to the screen displayed on the display unit 203 by the input unit 202.

Next, an explanation of the information projection apparatus 100 will be described. As illustrated in FIG. 2, the information projection apparatus 100 includes a communication unit 101, an operation unit 102, a storage unit 103, a projection display unit 104, a page management unit 105, a question management unit 106, and a question image generating unit 107.

The communication unit 101 sends and receives various information and requests with the question inputting apparatus 200. For example, the communication unit 101 receives the question information sent from the question inputting apparatus 200.

The projection display unit 104 projects various image data on the screen in a display format designated by a user.

The operation unit 102 accepts an operation request input to the information projection apparatus 100 from an external source. For example, the operation unit 102 accepts a command for interrupting the projection to the projection display unit 104 from the user. Further, the operation unit 102 accepts a command for restarting the projection which is interrupted to the projection display unit 104 from the user.

The operation unit 102 is, for example, an input device implemented with a button, a remote control receiver, and a card reader that reads out information from an IC card. Further, the operation unit 102 can include a keyboard.

The storage unit 103 is a storage medium, for example a hard disc drive apparatus (HDD), and stores a document data and an image list and so on. The document data is data generated by presentation material generation software or a word processor, or display data converted from these data, but it is not limited to these data.

When the page management unit 105 receives a question display request from the operation unit 102, the page management unit 105 identifies the question intended to be displayed. Further, the page management unit 105 sends a question image generating request to the question management unit 106 based on the identified question information, and acquires a display image corresponding to the request.

When the question management unit 106 receives the question information from the question inputting apparatus 200, the question management unit 106 adds a question identification and a questioner identification to the question information. The question identification and the questioner identification are identification management information. Further, when the question management unit 106 receives the question information from the question inputting apparatus 200, the question management unit 106 adds a display flag to the question information.

The question image generating unit 107 determines a size of the question image based on the question target position information and the question display position information included in the question information, and draws the question content and the questioner name.

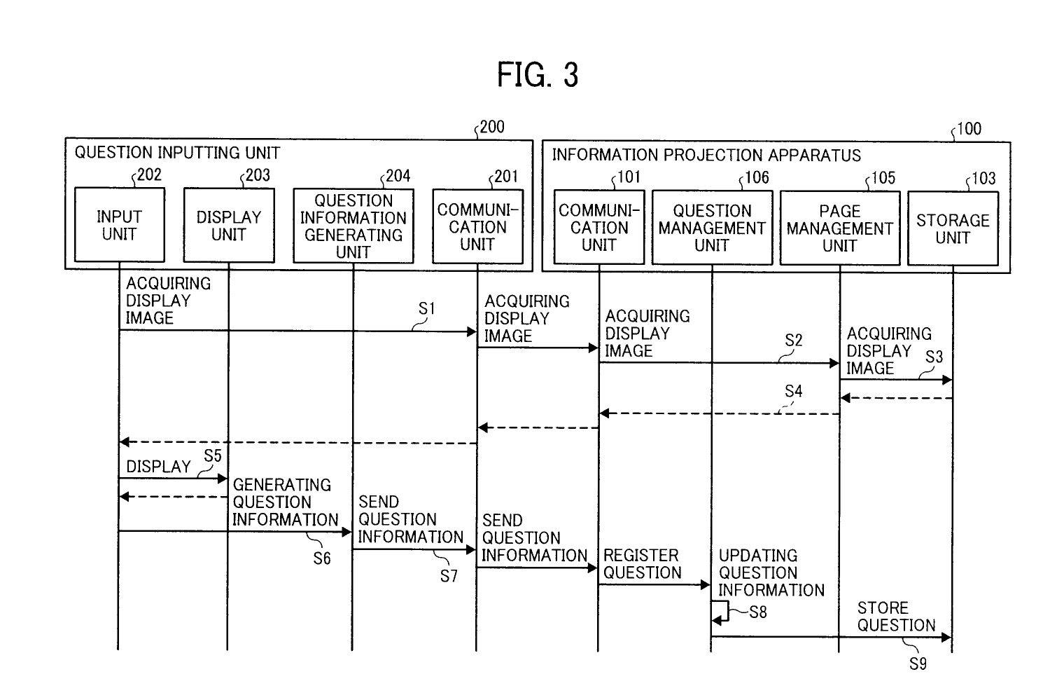

Next, in the information projection system 400 according to this embodiment, a process of registering the question information will be described. FIG. 3 is a sequence diagram illustrating the process of registering the question information.

Firstly, the question inputting apparatus 200 sends a request for acquiring the display image, the request being input from the input unit 202, to the information projection apparatus 100 through the communication unit 201 (step S1).

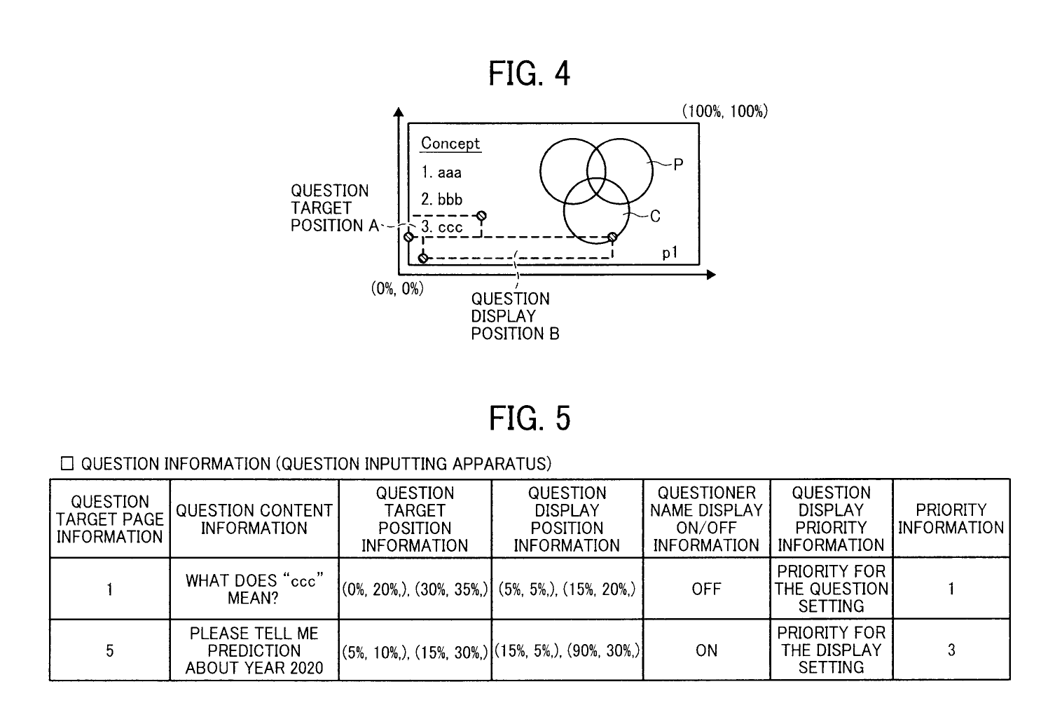

When the information projection apparatus 100 receives the request for acquiring the display image through the communication unit 101 (step S2), the information projection apparatus 100 acquires the display image (data used for display, which was part of the presentation) from the storage unit 103 with the page management unit 105 based on the request for acquiring the display image (step S3). For example, the acquired display image is illustrated as image P in FIG. 4.

Next, the information projection apparatus 100 sends the acquired display image (data used for display) to the question inputting apparatus 200 through the communication unit 101 (step S4).

Then, when the question inputting apparatus 200 receives the display image from the information projection apparatus 100 through the communication unit 201, the question inputting apparatus 200 displays the display image within the display unit 203 (step S5).

Next, the question inputting apparatus 200 generates the question information with the question information generating unit 204 based on an input from the questioner, with the input unit 202, to the image displayed on the display unit 203 (step S6).

FIG. 4 is a diagram illustrating one example of the input for generating question information. As illustrated in FIG. 4, the questioner designates the question target position A, the question display position B, and the question target page C, and inputs the question content, with the input unit 202, to the image displayed on his/her display unit 203.

For example, the questioner designates an area on his/her displayed image with a terminal such as a mobile PC by using a mouse for designating the question target position A and the question display position B.

On this occasion, the question target position or the question display position can be determined by the order of the input of the area. Relative coordinates are derived from absolute coordinates of the question target position and the question display position input with the mouse. The relative coordinates are regarded as the question display position B and the question target position A.

Through his/her input unit 202, the questioner designates the question target position A and the question display position B. Thus, the briefer can understand the questions easily. When the question is input as described above, the question inputting apparatus 200 generates the question information with the question content information generating unit 204, based on the question information, the question target position A information, the question display position B information, and the question target page C information. Then, the question inputting apparatus 200 sends the question information to the information projection apparatus 100 through the communication unit 201 (step S7, FIG. 3).

One example of the question information generated in the question inputting apparatus 200 and sent to the information projection apparatus 100 is illustrated in FIG. 5.

In the example illustrated in FIG. 5, page 1 and page 5 are designated as question target pages, and the question content information, the question target position information, and the question display position information are input on “Ichiro's” (the example name of the questioner) question inputting apparatus 200. The question content information denotes the contents of questions of the questioner. The question target page information denotes the page of the material on which the questioner has a question. The question target position information denotes the position on the page on which the questioner has a question. The question display position information denotes the position on the page on which the questioner wants to display the question content.

In addition, the question information can include priority information, questioner name display on/off information, and question display priority information.

The priority information is information to denote a priority of the question. The questioner can designate the priority of the question as the priority information. For example, the priority information “3” is highest priority, and the lower the number, the lower the priority.

The questioner can set whether or not to display the name of the questioner by the questioner name display on/off information. In the case the questioner name display on/off information is on, the question content and the questioner name are displayed. In the case the questioner name display on/off information is off, only the question content is displayed, so the question can be asked anonymously.

The questioner can set whether to make the font smaller or display a portion of the question content in a case in which the question content can not be displayed in the display area in a standard format, as question display priority information. For example, in the one case in which the question display priority information is set to a priority for the question setting and the question content can not be displayed in the display area in a standard format, the size of font can be automatically made smaller so that the question content can be fully displayed in the display area. As the other example, in the other case in which the question display priority information is set to a priority for the display setting and the question content can not be displayed in the display area in a standard format, only a portion of the question content will be displayed.

Thus the image data and the question content are displayed in the same projection area, to make an indication point clearer. The questioner can also designate the area for displaying the question, and the image data and the question can be displayed on one page by adjusting the font size.

Next, when the information projection apparatus 100 receives the question information through the communication unit 101, the information projection apparatus 100 updates the question information by adding the question identification, the questioner identification, and the display flag to the question information with the question management unit 106 (step S8, FIG. 3). The question identification is assigned by the order of receiving the question. Further, the questioner identification is assigned based on the question inputting apparatus 200 that sends the question information.

Next, the information projection apparatus 100 stores the question information in the storage unit 103 (step S9, FIG. 3).

FIG. 6 is a diagram illustrating a data structure of the question information. As illustrated in FIG. 6, the question information includes the question identification, the questioner identification, the display flag, the question content information, the question target page information, the question display position, and the question target position. As described above, the question content information, the question target page information, the question display position information, and the question target position information are generated in the question inputting apparatus 200 based on the input of the questioner. Further, as illustrated in FIG. 6, the question information can include the priority information, the questioner name display on/off information, and the question display priority information.

As described above, the information projection apparatus 100 adds the question identification, the questioner identification, and the display flag to the question information with the question management unit 106. The question identification is an identification of the question information. The question identification is assigned by the order of receiving the question by the question management unit 106. The questioner identification is identification of the questioner. The questioner identification is assigned based on the question inputting apparatus 200 that sends the question information.

The display flag is a flag to denote whether or not the question information is being displayed as the question image.

There are “not displayed”, “currently displayed”, “terminated”, and “terminated and necessity to check” as kinds of flags. The flag “terminated and necessity to check” denotes that the display is terminated but a check is needed. At a timing of receiving the question, the display flag is set to “not displayed” by the question management unit 106. The page management unit 105 can alter the flag depending on the situation. For the value of the display flag, for example, “0” denotes “not displayed”, “1” denotes “currently displayed”, “2” denotes “terminated”, and “3” denotes “terminated and necessity to check”.

For example, the briefer can mark the question with the operation unit 102 for reconfirming during the question and answer period. The page management unit 105 can then send a notification of the mark to the question management unit 106. The question management unit 106 can then alter the display flag from “currently displayed” (the value of the display flag is “1”) to “terminated and necessity to check” (the value of the display flag is “3”).

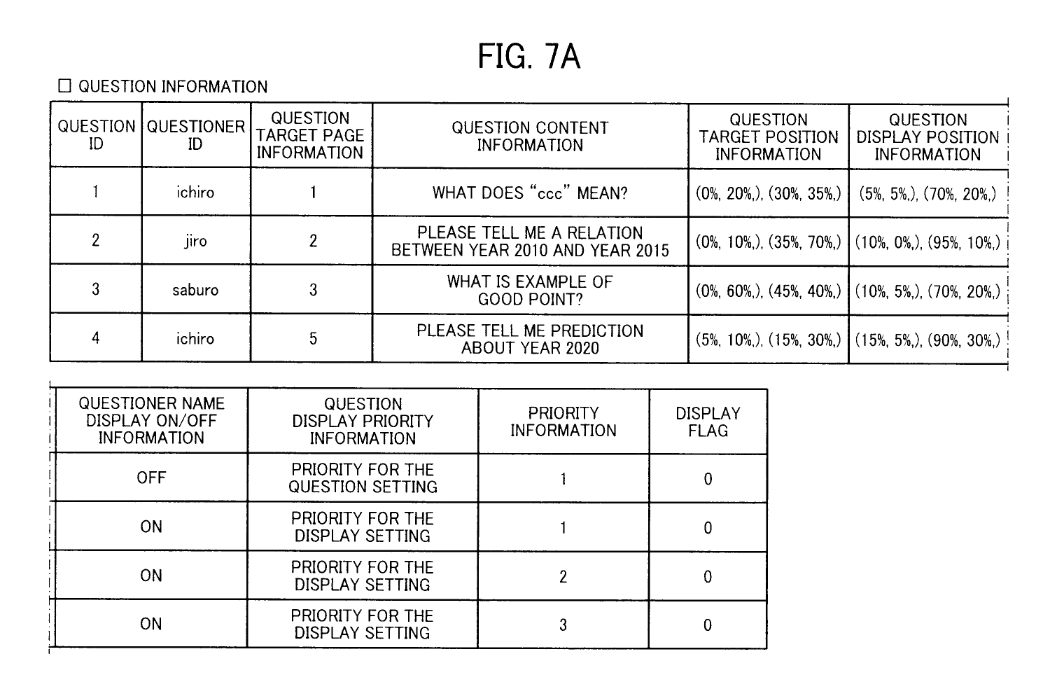

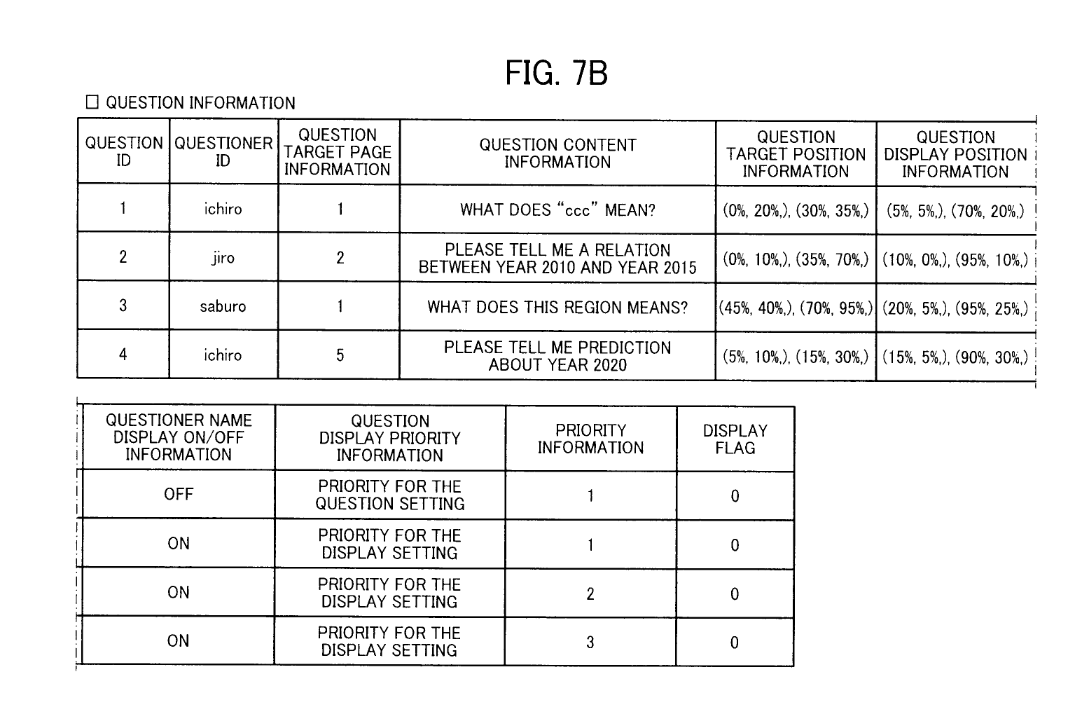

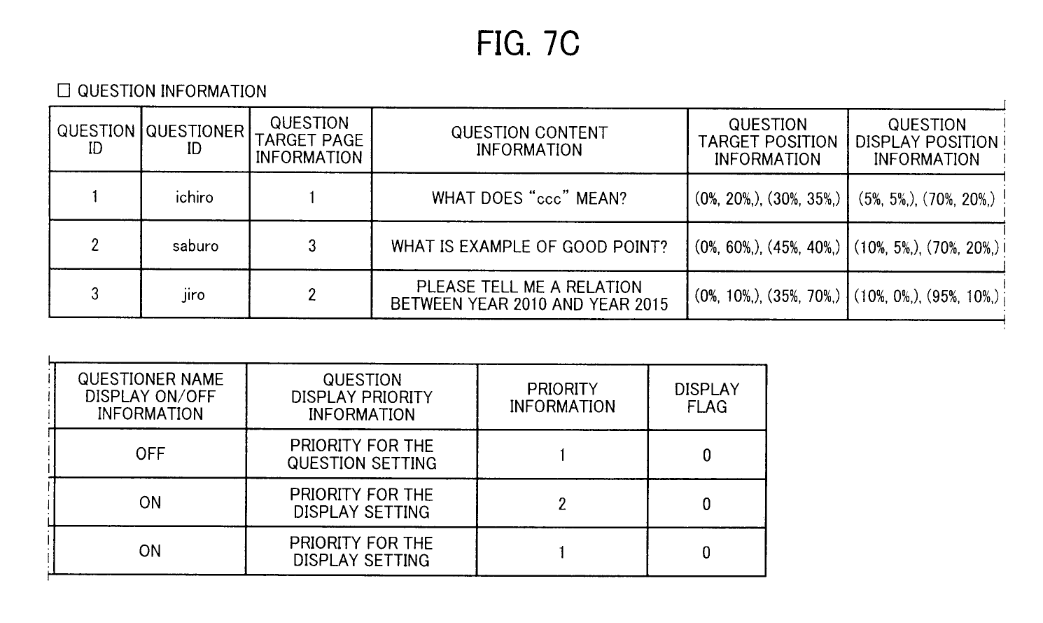

Examples of the question information are illustrated in FIGS. 7(a)-7(c). The question information illustrated in FIG. 7(a) includes the question target page information, the question content information, the question display position information, the question target position information, the priority information, the questioner name display on/off information, and the question display priority information which are generated on “Ichiro's” question inputting apparatus 200 (in this example “Ichiro” is the name of the questioner). And the question information includes the question identification (“1”), the questioner identification (“Ichiro”), and the display flag (“0”) which are added by the information projection apparatus 100.

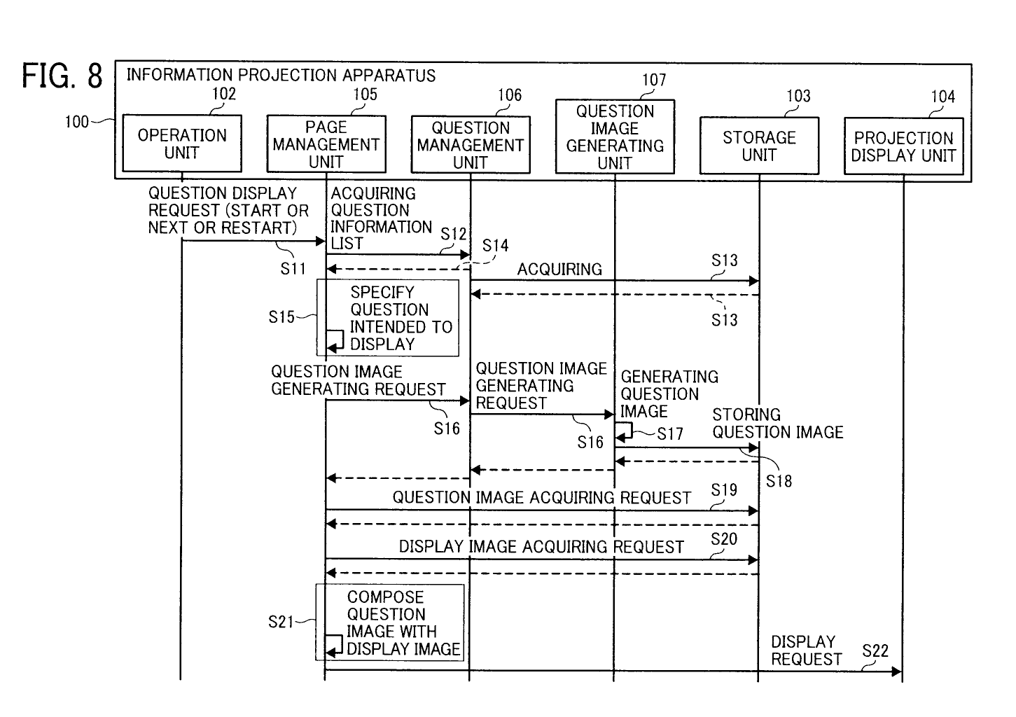

Next, a process of composing the question image with the display image will be described. FIG. 8 is a sequence diagram illustrating the process of composing the question image with the display image.

When the information projection apparatus 100 receives the question display request from the operation unit 102 after a start of the question and answer period (step S11), the page management unit 105 sends a question information list acquiring request to the question management unit 106 (step S12). Next, the question management unit 106 acquires the question information list stored in the storage unit 103 (step S13), and sends the question information list to the page management unit 105 (step S14).

The information projection apparatus 100 identifies the question information intended to be displayed with the page management unit 105 (step S15). The information projection apparatus 100 then sends the question image generating request to the question image generating unit 107 based on the question information (step S16).

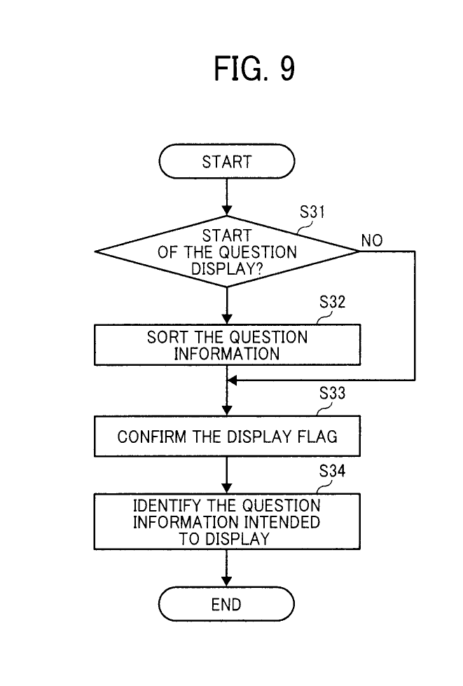

A process of designating the question information intended to be displayed will be described with reference to the FIG. 9.

As illustrated in FIG. 9, when the page management unit 105 receives the question display request firstly at a timing of the start of the question display after an end of the presentation (step S31: YES), the page management unit 105 sorts the question information in the question information list (step S32). The page management unit 105 then confirms the display flag (step S33), and identifies the question information intended to be displayed (step S34).

On the other hand, when the page management unit 105 receives the question display request secondly or later (step S31: No), the page management unit 105 does not sort the question information in the question information list. The page management unit 105 then confirms the display flag (step S33), and identifies the question information intended to display (step S34).

Processes of sorting the question information will be described. In the case in which the sorting of the question information is not executed, the question information are displayed in the order the question identification is received. In the case in which the sorting of the question information is not executed, in the question information illustrated in FIG. 7, at a start of the question and answer period, the question with the question identification “1” (the first received question) is displayed. And when the page management unit 105 receives the question display request secondly, the question with the question identification “2” (the next received question) is displayed.

However, generally, questions to the same page are preferably mutually associated. Therefore, a first sorting technique sorts the question information to be ordered so that question information to the same page are sequenced. In the example of the question information illustrated in FIG. 7(b), the question with the question identification “1” (the question target page is page “1”) is firstly displayed. Then the question with the question identification “3” (the question target page is also page “1”) is secondly displayed, and the question with the question identification “2” (the question target page is the next page “2”) is thirdly displayed, and the question with the question identification “4” (the question target page is the next page having a question, page “5”) is fourthly displayed. Thus efficiency of the question and answer period of the meeting can be improved as the questions are sorted starting from the earliest page having a question.

A second sorting technique sorts the question information to be in an order of pages and incremented by 1. In the example of the question information illustrated in FIG. 7(c), the question with the question identification “1” (the question target page is page “1”) is firstly displayed. Then the question with the question identification “3” (the question target page is page “2”) is secondly displayed, and the question with the question identification “2” (the question target page is page “3”) is thirdly displayed.

A third sorting technique sorts the question information to be in an order in which the question information to the same questioner are sequenced. In the example of the question information illustrated in FIG. 7(a), the question with the question identification “1” (the questioner is “Ichiro”) is firstly displayed. Then the question with the question identification “4” (the second question from the same questioner “Ichiro”) is secondly displayed, and the question with the question identification “2” (the first question from the next questioner “Jiro”) is thirdly displayed, and the question with the question identification “3” (the first question from the next questioner “Saburo”) is fourthly displayed.

A fourth sorting technique counts a number of questions for each page every time the question display start request is received, and sorts the question information in a descending order of a number of the questions for the same page. In this case the page with the most questions is first displayed, and so on. In the example of the question information illustrated in FIG. 7(b), the question with the question identification “1” (the question target page is page “1”) is firstly displayed. In this case page “1” has the most questions. The question with the question identification “3” (the question target page is page “1”) is secondly displayed, and the question with the question identification “2” (the question target page is page “2”, page 2 has the second largest number of questions and a lower question identification than any other page that has same number of questions) is thirdly displayed, and the question with the question identification “4” (the question target page is page “5”) is fourthly displayed.

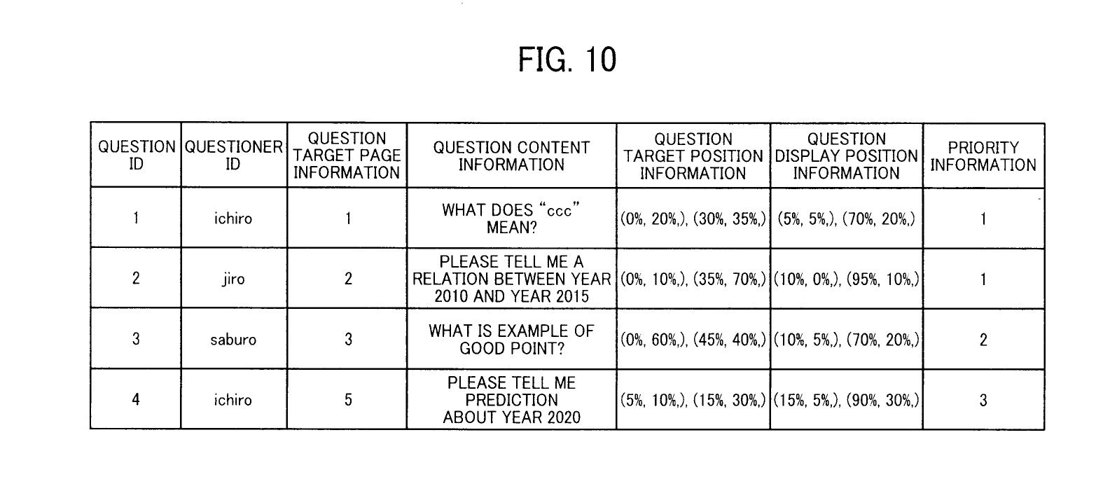

A fifth sorting technique adds the priority information to the question information, and sorts the question information in a descending order based on the priority information. In the example of the question information illustrated in FIG. 10, the question with the question identification “4” (the priority information is highest priority “3”) is firstly displayed. The question with the question identification “3” (the priority information is next highest priority “2”) is secondly displayed, and the question with the question identification “1” (the priority information is the lowest priority “1”) is thirdly displayed, and the question with the question identification “2” (the priority information is also the lowest priority “1”) is fourthly displayed. Thus, the briefer can answer the important questions preferentially. Efficiency of the question and answer period of the meeting can thereby be improved.

The display flag can be used in a way now described. For example, at the start of the question and answer period of the meeting, all questions are not displayed (so all display flags are “0”), so the first question in the sorted questions is identified as the question information intended to be displayed and the display flag of the first question is set to “1”. Then, at the restart of the question and answer period of the meeting, the first question whose the display flag is “0” in the sorted questions is identified as the question information intended to be displayed and the display flag of the first question is set to “1”.

Further, when a question display request is continuously received, the question currently displayed (having the display flag set to “1”) is found and the question's display flag is set to “2”. In the case in which there are questions which are not displayed (their display flag is “0”), the first question whose the display flag is “0” in the sorted questions is identified as the question information intended to be displayed and the display flag of that first question is set to “1”. In the case in which there are no more questions which are not displayed (no display flags are “0”), the first question whose display flag is “3” in the sorted questions is identified as the question information intended to be displayed and the display flag of that question is set to “1”.

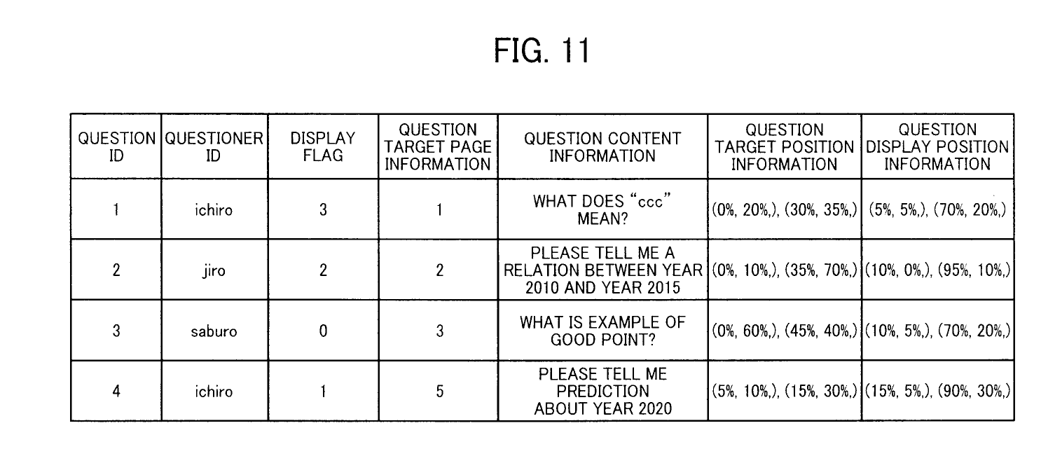

In the example of the question information illustrated in FIG. 11, the question with the question identification “3” (the display flag is “0”) is firstly displayed. Then the question with the question identification “1” (the display flag is “3”) is secondly displayed. Thus, the question information which is not displayed or displayed but that needs to be reconfirmed can be displayed again by adding the display flag to the question information.

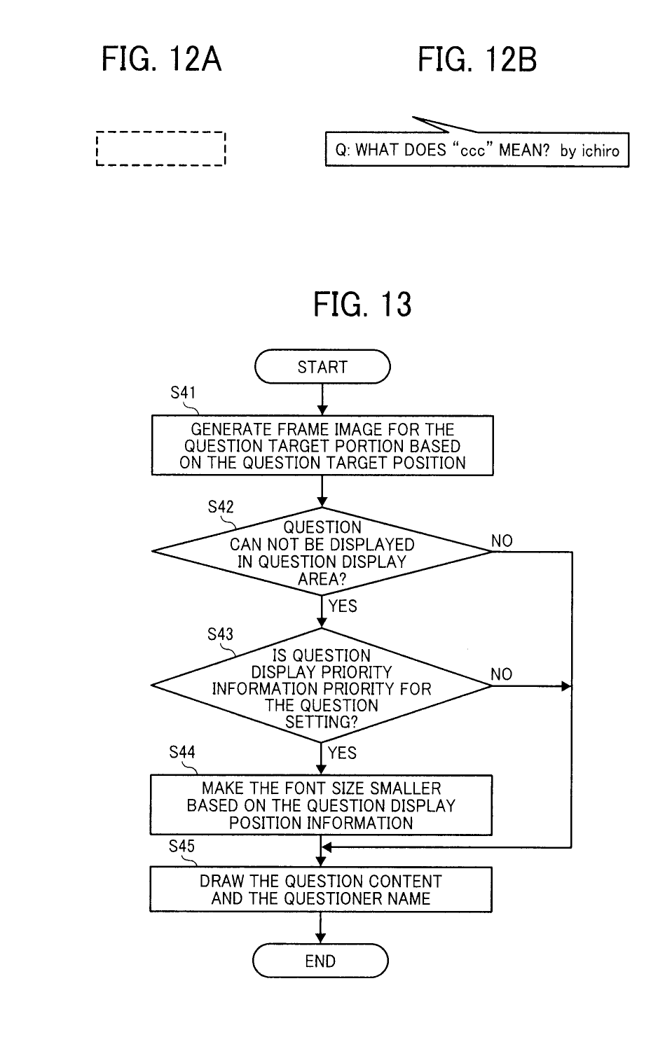

The explanation of FIG. 8 will be described again. The information projection apparatus 100 generates the question image based on the question information with the question image generating unit 107 (step S17). FIGS. 12(a), 12(b) are diagrams illustrating a process of generating the question image. As illustrated in FIG. 12(a), in the process of generating the question image, the image size which displays the question target position is decided based on the question target position information and the image is generated. Next, as illustrated in FIG. 12(b), the image size which displays the question is decided based on the question display position information and the question content and the questioner name is drawn into the image.

The information projection apparatus 100 stores the question image generated by the question image generating unit 107 in the storage unit 103 (step S18).

Next, the information projection apparatus 100 sends the question image acquiring request to the storage unit 103 by the page management unit 105 (step S19) and sends the display image acquiring request (step S20).

Next, the information projection apparatus 100 acquires the question image and displays the image from the storage unit 103 and composes the question image with the display image (step S21), and sends the display request of the composed image to the projection display unit 104.

A process of composing the question image with the display image will be described below with reference to a flowchart diagram of FIG. 13. As illustrated in FIG. 13, firstly, the page management unit 105 generates a frame image for the question target portion based on the question target position (step S41). In the step S42, the page management unit 105 determines whether or not the question content can be displayed in a question display area.

In the case in which the page management unit 105 determines the question content can not be displayed in the question display area (step S42: YES), and the question display priority information is the priority set for the question setting (step S43: YES), the page management unit 105 makes the font size smaller based on the question display position information (step S44), and draws the question content and the questioner name (step S45). Therefore, in the case in which the question content can not be displayed in the question display area normally in a standard format, the font size is made smaller so that the question content can still be displayed in the question display area.

In the case in which the page management unit 105 determines the question content can be displayed in the question display area (step S42: NO), or the question content can be displayed in the question display area (step S42: YES) and the question display priority information is set for the priority for the display setting (step S43: NO), the page management unit 105 does not make the font size smaller, and draws the part of question content and the questioner name (step S45).

Next, an embodiment of the composed image that is generated from the question image and display image will be described.

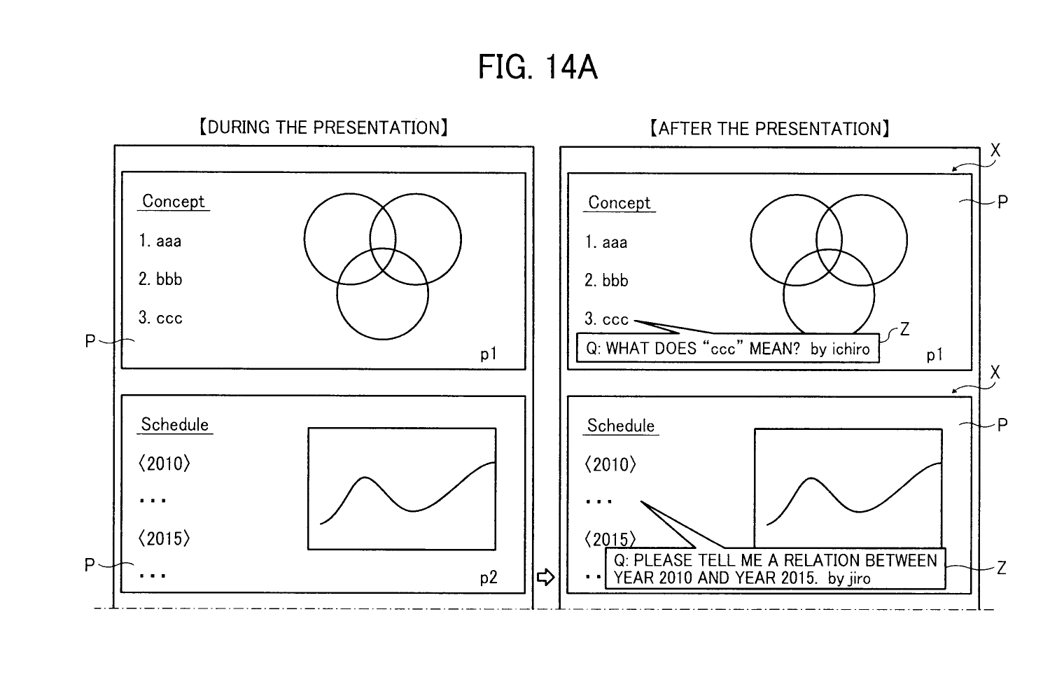

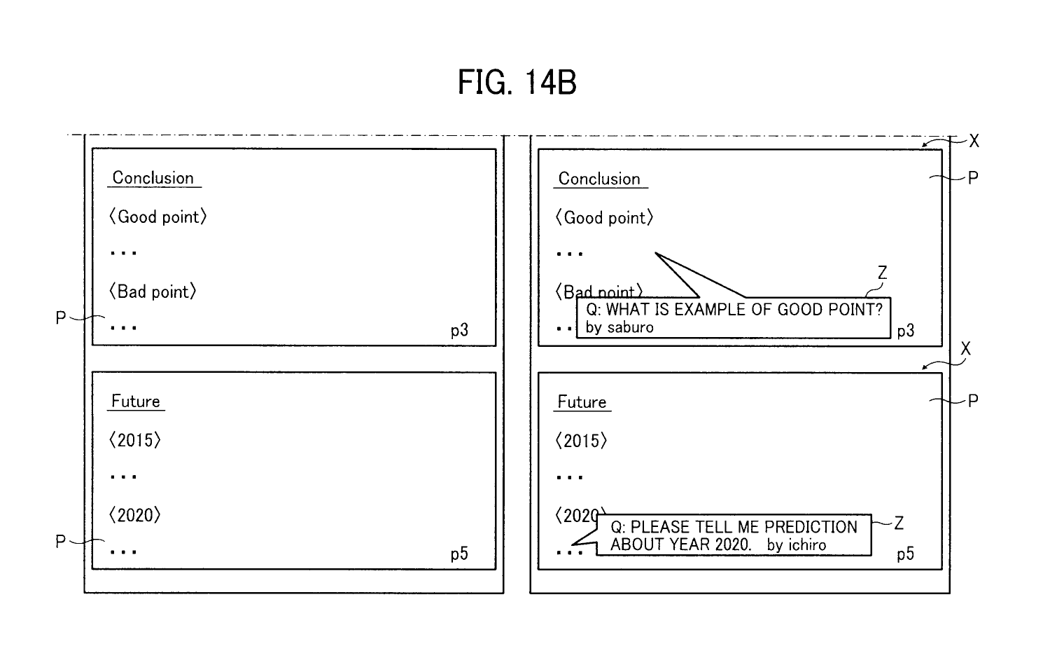

FIG. 14 is a diagram illustrating a display image P during the presentation and a diagram illustrating an example of a composed image X after the presentation. As illustrated in FIG. 14, the composed image X displayed after the presentation includes the question image Z (the image denotes a target of the question and the image denotes the question content) composed in the order of the question identification illustrated in FIG. 7(a) and displayed by the projection display unit 104.

Further, as illustrated in FIG. 14, the page management unit 105 generates the question image Z for each question. The question content is displayed in a way to not overlap the target of the question, so the target of the question is made clear. The briefer can then understand the question more easily.

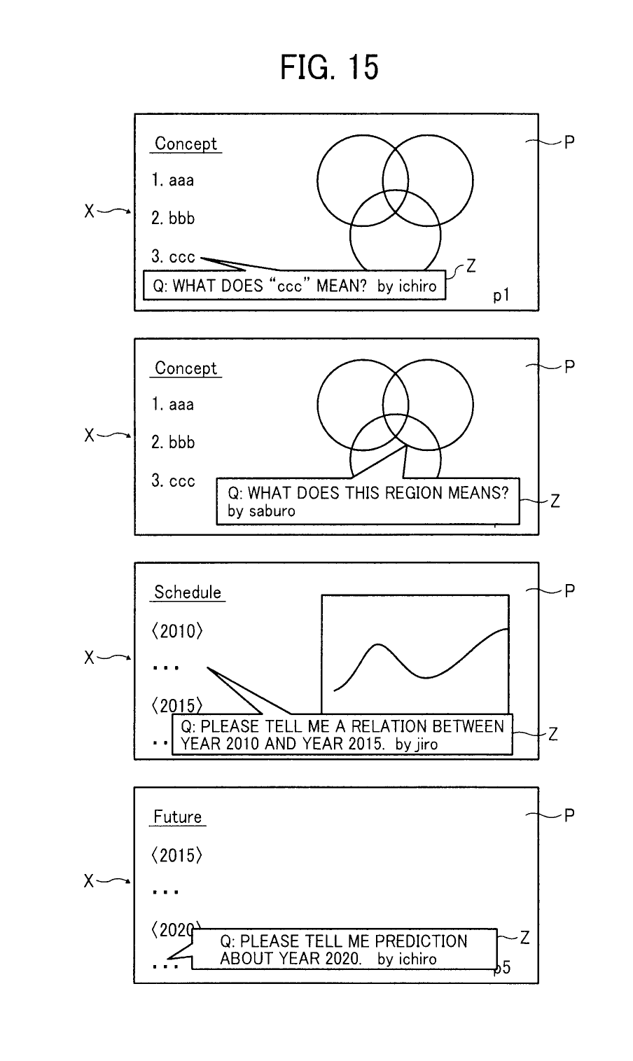

FIG. 15 is a diagram illustrating another example of the composite image displayed after the presentation. As illustrated in FIG. 15, the question images are sorted so that the question images whose question target page are the same will be sequential. The question images whose question target page are the same are composed and displayed sequentially in the composed image X displayed after the presentation by the projection display unit 104. In the example of the question information illustrated in FIG. 7(b), the question with the question identification “1” (the question target page is page “1”) is firstly displayed. Then the question with the question identification “3” (the next question with the question target page is also page “1”) is secondly displayed, and the question with the question identification “2” (the question target page is next page “2”) is thirdly displayed, and the question with the question identification “4” (the question target page is the next page with a question, page “5”) is fourthly displayed. When the page management unit 105 displays a next image, in the case in which there are similar questions to the image displayed right before, the page management unit 105 generates the question image Z for the question. The questions to the same page can thereby be mutually associated. Thus efficiency of the question and answer period of the meeting can be improved.

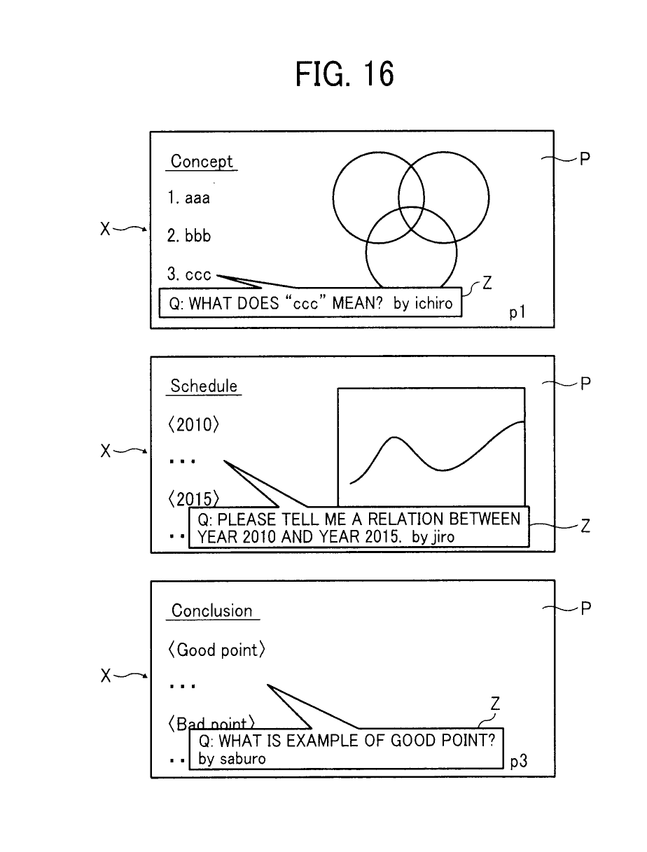

FIG. 16 is a diagram illustrating another example of the composite image that can be displayed after the presentation. As illustrated in FIG. 16, the question images are sorted so that for the question images the question target page will be sequentially ascending. That is, the question images are composed and displayed, so that the question's are sorted based on the question target page being sequentially ascending, in the composed image X displayed after the presentation by the projection display unit 104. In the example of the question information illustrated in FIG. 7(c), the question with the question identification “1” (the question target page is page “1”) is firstly displayed. Then the question with the question identification “3” (the question target page is next page “2”) is secondly displayed, and the question with the question identification “2” (the question target page is next page “3”) is thirdly displayed.

Thus, The page management unit 105 generates the composed image X in order of ascending page sequence. Therefore the order of the questions and answers will be the same as the order of the presentation. The briefer can thereby execute the question and answer period in the same order of the presentation, which can make the briefer answer the questions more easily.

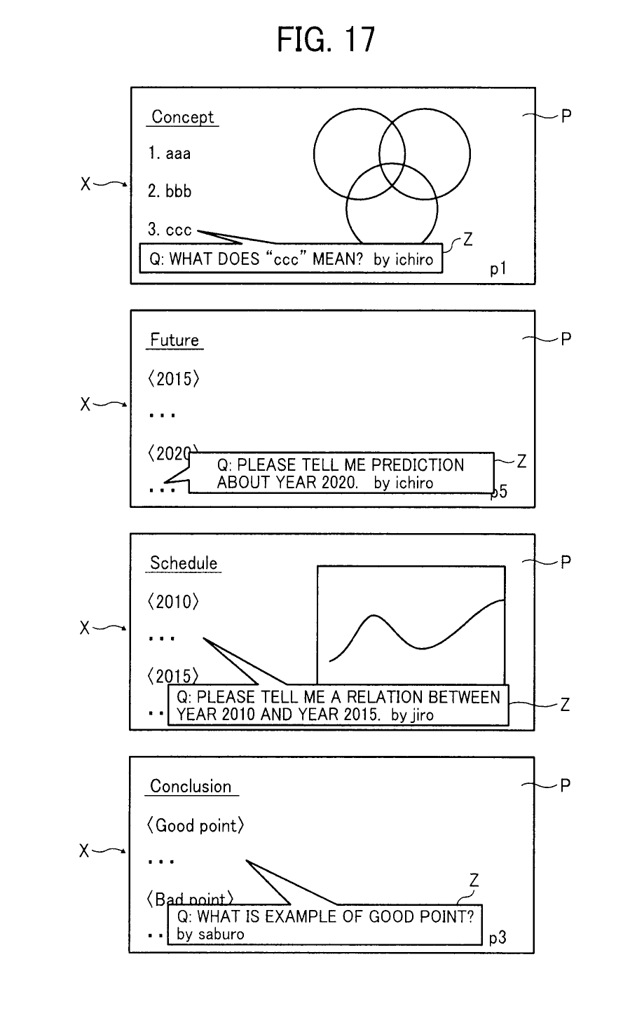

FIG. 17 is a diagram illustrating another example of the composite image that can be displayed after the presentation. As illustrated in FIG. 17, the question images are sorted so that the questions from the same questioner will be sequential. That is the question images are composed and displayed, so that the questions from the same questioner will be sequential, in the composed image X displayed after the presentation by the projection display unit 104. In the example of the question information illustrated in FIG. 7(a), the question with the question identification “1” (the questioner is “Ichiro”) is firstly displayed. Then the question with the question identification “4” (the questioner is also “Ichiro”) is secondly displayed, and the question with the question identification “2” (the questioner is “Jiro”) is thirdly displayed, and the question with the question identification “3” (the questioner is “Saburo”) is fourthly displayed. Thus, The page management unit 105 generates the composed image X so that the questions from the same questioner will be sequentially displayed.

The briefer can thereby answer the questions from the same questioner at one time. Thus, efficiency of the question and answer period of the meeting can be improved.

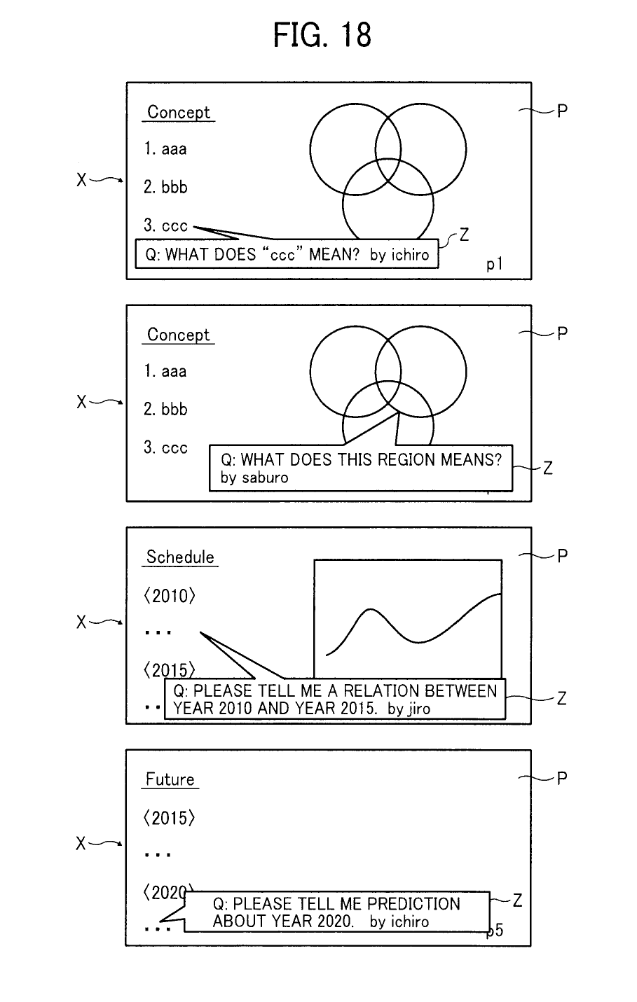

FIG. 18 is a diagram illustrating another example of the composite image that can be displayed after the presentation. As illustrated in FIG. 18, the question images are sorted in descending order of the number of questions from a same question target page. That is, the question images are composed and displayed in descending order of the number of questions from a same question target page, in the composed image X displayed after the presentation by the projection display unit 104. In the example of the question information illustrated in FIG. 7(b), the question with the question identification “1” (the question target page is page “1”) is firstly displayed. Then the question with the question identification “3” (the next question with the target page “1”) is secondly displayed, and the question with the question identification “2” (the question target page is page “2”, page “2” has the second largest number of questions and a smaller question identification than any other page that has the same number of questions) is thirdly displayed, and the question with the question identification “4” (the question target page is next page “5” with questions) is fourthly displayed.

Thus the page management unit 105 displays the pages in the order corresponding to the number of questions for a page. The pages which the audience are more interested in can thus be displayed early. Thus efficiency of the question and answer period of the meeting can be improved.

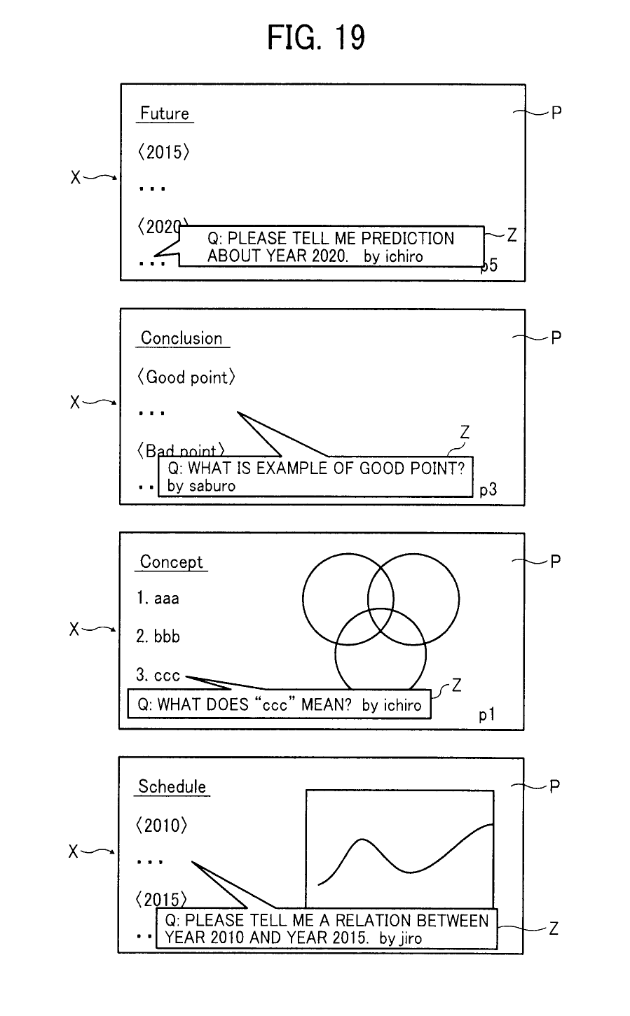

FIG. 19 is a diagram illustrating another example of the composite image that can be displayed after the presentation. As illustrated in FIG. 19, the question information has the priority information added thereto. The question images are composed and displayed in descending order of the priority, in the composed image X displayed after the presentation by the projection display unit 104. In the example of the question information illustrated in FIG. 10, the question with the question identification “4” (the priority information is highest priority “3”) is firstly displayed. Then the question with the question identification “3” (the priority information is the next highest priority “2”) is secondly displayed, and the question with the question identification “1” (the priority information is the lowest priority “1”) is thirdly displayed, and the question with the question identification “2” (the priority information is also the lowest priority “1”) is fourthly displayed.

Thus, the briefer can answer the important questions preferentially. Efficiency of the question and answer period of the meeting can thereby be improved.

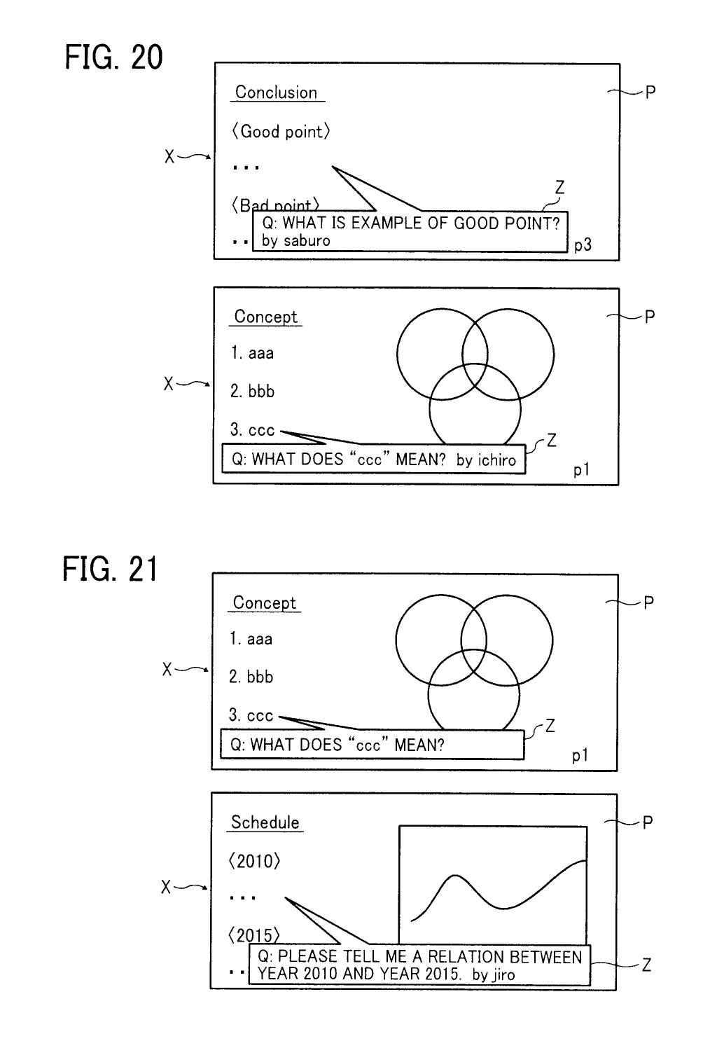

FIG. 20 is a diagram illustrating another example of the composite image that can be displayed after the presentation. As illustrated in FIG. 20, by using the display flag, the question images are composed and displayed in the composed image X after the presentation by the projection display unit 104.

In the example of the question information illustrated in FIG. 11, the question with the question identification “3” (the display flag is “0”) is firstly displayed. Then the question with the question identification “1” (the display flag is “3”) is secondly displayed. Thus, the question information that is not displayed or that is displayed but needs to be reconfirmed can be displayed again by adding the display flag to the question information.

FIG. 21 is a diagram illustrating another example of the composite image that can be displayed after the presentation. As illustrated in FIG. 21, by using the questioner name display on/off information, the question images are composed and displayed in the composed image X displayed after the presentation by the projection display unit 104.

In the example of the question information illustrated in FIG. 7(c), the questioner name with the question identification “2” (the questioner's name display on/off information is “on”) is displayed. On the other hand, the questioner name with the question identification “1” (the questioner's name display on/off information is “off”) is not displayed.

Thus, whether or not the questioner name is displayed can be set for each question. The questioner can thereby ask a question anonymously.

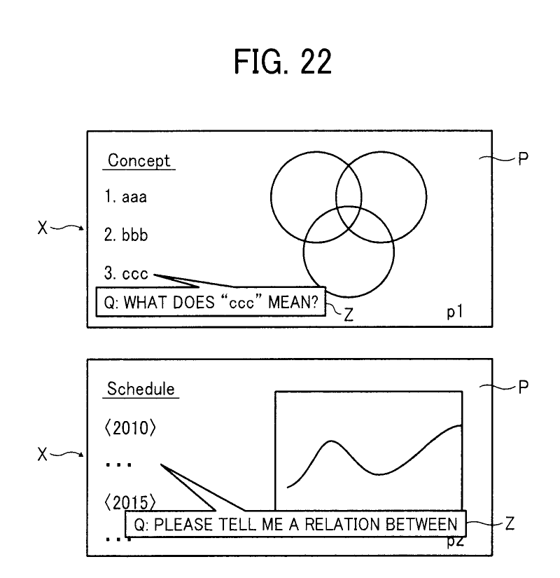

FIG. 22 is a diagram illustrating another example of the composite image that can be displayed after the presentation. As illustrated in FIG. 22, by using the question display priority information, the question images are composed and displayed in the composed image X displayed after the presentation by the projection display unit 104.

In the example of the question information illustrated in FIG. 7(b), the question with the question identification “1” (the question display priority information is set to “the priority for the question setting”) is displayed by making the font size smaller so that whole question can be displayed in the area. On the other hand, a part of the question with the question identification “2” (the question display priority information is set to “the priority for the display setting”) is displayed without making the font size smaller. Whether to prioritize for a whole of the question to be displayed or to prioritize for keeping the font size can be set for each question by using the question display priority information. That is, in the case in which the question content can not be fully normally displayed in the question display area in a standard format, whether to prioritize that the whole question content is displayed or to prioritize keeping the font size can be set for each question. In this embodiment, controlling an order of showing questions can also be performed.

Thereby the portion targeted question in the page is made clearer. The briefer can then better understand the questions more easily, and efficiency of the question and answer period of the meeting can be improved.

The information projection apparatus 100 according to this embodiment includes a control apparatus such as a CPU, a storage apparatus such as a read only memory (ROM), RAM, HDD, and an external storage apparatus such as a CD drive apparatus. A hardware configuration of the information projection apparatus 100 is a hardware configuration utilized with a general computer.

Programs executed in the information projection apparatus 100 according to this embodiment are stored in a computer readable storage medium such as a CD-ROM, flexible-disk (FD), CD-R, digital versatile disk (DVD), as in an installable file format or executable file format.

Further, programs executed in the information projection apparatus 100 according to this embodiment can be stored in a computer on a network such as an internet and can be provided by downloading. Further, programs executed in the information projection apparatus 100 according to this embodiment can be provided through the network such as an internet. Further, programs executed in the information projection apparatus 100 according to this embodiment can be stored in the ROM.

Further, programs executed in the information projection apparatus 100 according to this embodiment can have a module organization including each unit described above (the communication unit 101, the operation unit 102, the storage unit 103, the page management unit 105, the question management unit 106, and the question image generating unit 107). The CPU reads out the programs from the storage medium and executes the programs so that these units described above are loaded in the main storage apparatus. And the communication unit 101, the operation unit 102, the storage unit 103, the projection display unit 104, the page management unit 105, the question management unit 106, and the question image generating unit 107 can be generated on the main storage apparatus.

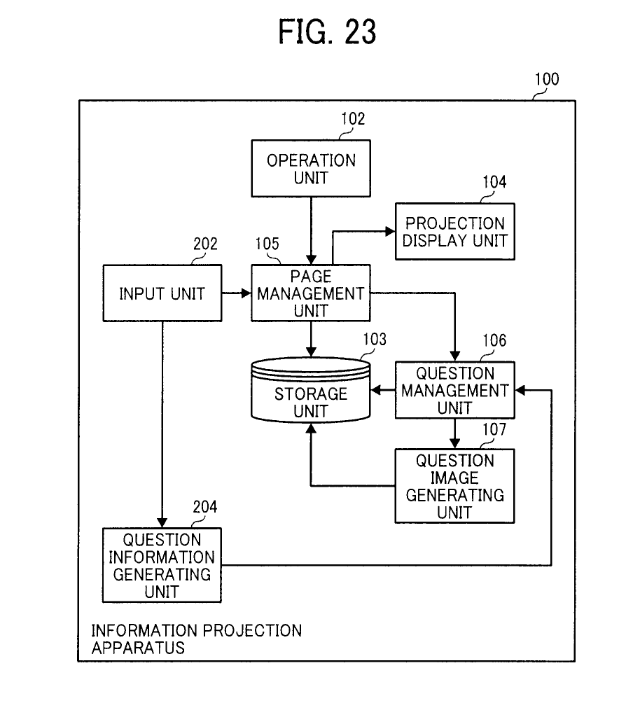

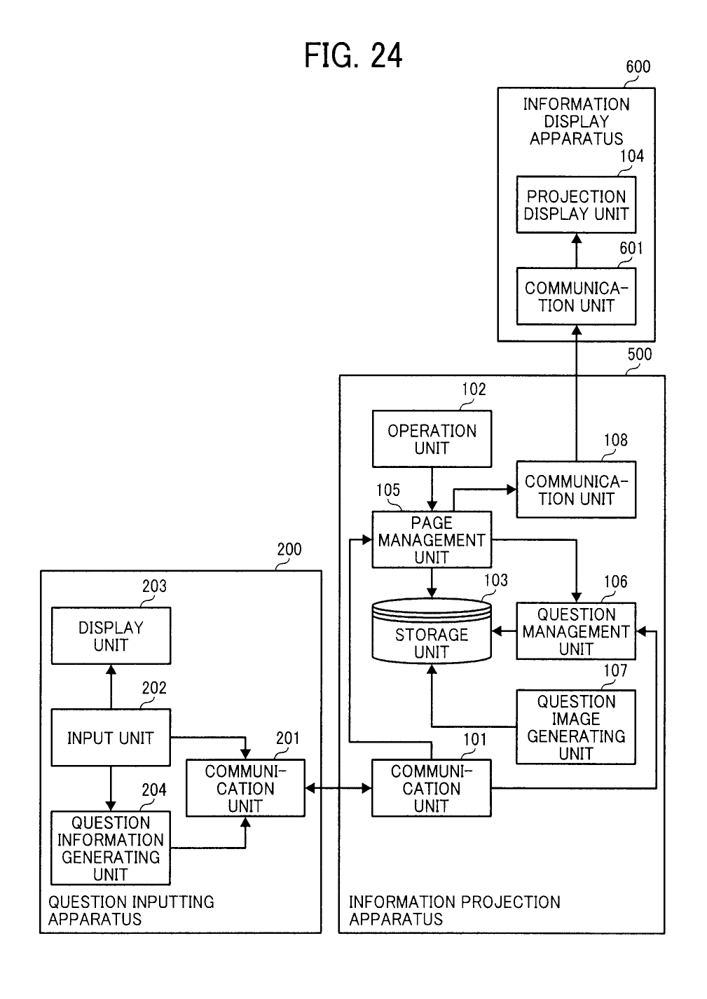

In the information projection system 400 according to this embodiment, the information projection apparatus 100 and the question inputting apparatus 200 are mutually connected through the network 300. But the configuration is not limited to this system configuration. A system configuration in which the information projection apparatus 100 includes functions of the question inputting apparatus 200, as shown illustrated in FIG. 23, can also be implemented.

Further, as illustrated in FIG. 24, the information projection system 400 can include the question inputting apparatus 200, the information processing apparatus 500, and the information display apparatus 600.

The information processing apparatus 500 includes a plurality of functions, included in the information projection apparatus 100, other than the projection display unit 104 (the communication unit 101, the operation unit 102, the storage unit 103, the page management unit 105, the question management unit 106, and the question image generating unit 107) and the communication unit 108 which communicates with information display apparatus 600.

When the page management unit 105 generates the composed image, the page management unit 105 sends the display request of the composed image to the information display apparatus 600 through the communication unit 108.

The information display apparatus 600 includes the projection display unit 104 and a communication unit 601 that communicates with information processing apparatus 500.

When the projection display unit 104 receives the display request of the composed image, the projection display unit 104 projects the composed image on the screen.

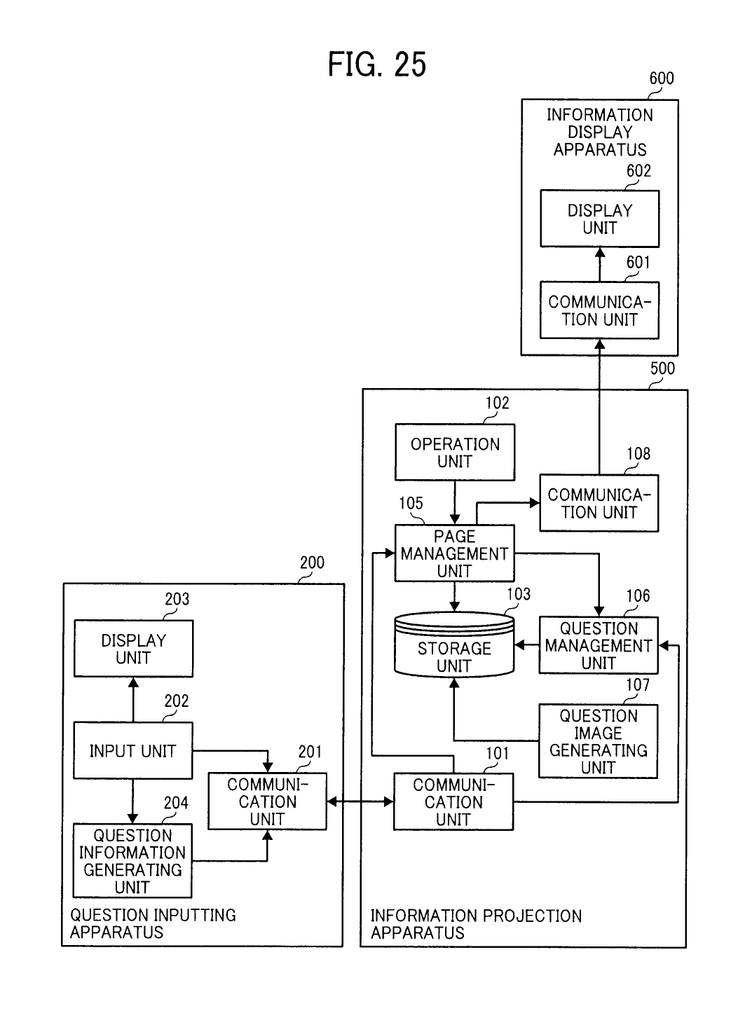

Further, as illustrated in FIG. 25, the information display apparatus 600 can include the display unit 602 that displays various images on the display instead of on the projection display unit 104. The information display apparatus 600 is not limited to the information projection apparatus, and can also include a display apparatus.

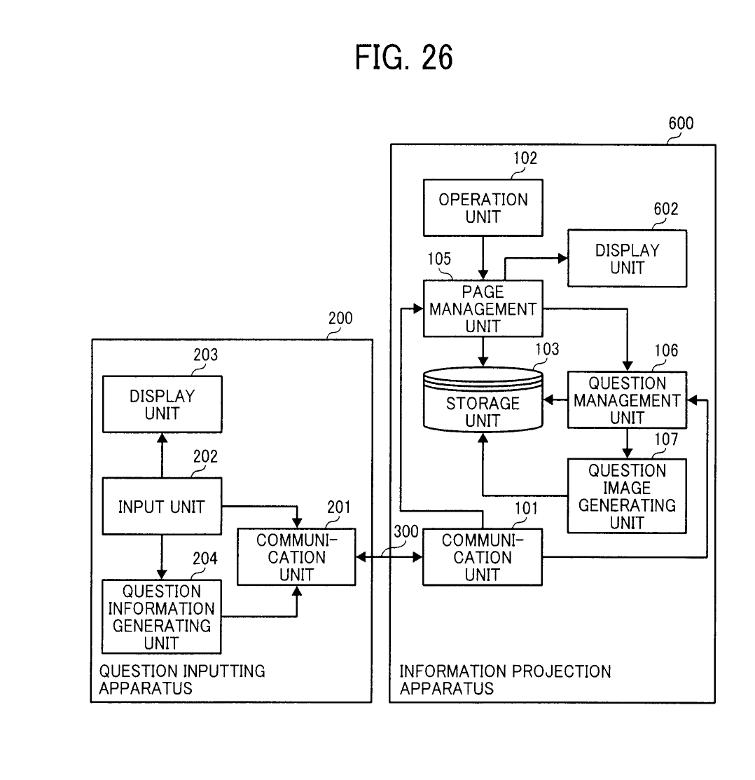

Further, as illustrated in FIG. 26, the information projection system 400 can include the question inputting apparatus 200 and the information display apparatus 600. And the information display apparatus 600 can include the display unit 602 that displays various images on the display instead of on the projection display unit 104.

Obviously, numerous modifications and variations of the present invention are possible in light of the above teachings. It is therefore to be understood that within the scope of the appended claims, the invention may be practiced otherwise than as specifically described herein.

What is claimed is:

1. An information display apparatus, comprising:
a question management unit that adds identification management information to question information, the question information including (1) a question which is asked with designating an image displayed by the display unit and (2) a question target page;
a question image generating unit that generates a question image based on the question information;
an operation unit that accepts requests from an external source;
a page management unit that determines an order of the question target page for displaying based on the identification management information and that composes the display image with the question image to generate a composed image based on the determined order; and
a display unit that displays the composed image.

2. The information display apparatus as claimed in claim 1,
wherein:
the question information includes a question target position information that denotes a portion of the page subjected to the question and a question display position information that denotes a portion of the page designated to display the question; and
the page management unit generates the question image for each question based on the question target position and the question display position.

3. The information display apparatus as claimed in claim 1,
wherein:
the page management unit sorts the composed images so that the composed images are sequentially sorted based on the question target page, so that all questions from a same target page are sorted adjacently.

4. The information display apparatus as claimed in claim 1,
wherein:
the page management unit sorts the composed images so that the question target page of the composed images are sequentially sorted based on the question target page, in an ascending numerical order of the question target page.

5. The information display apparatus as claimed in claim 1,
wherein:
the identification management information includes a questioner identification that identifies a questioner; and
the page management unit sorts the composed images so that the composed images from a same questioner are sorted sequentially.

6. The information display apparatus as claimed in claim 1,
wherein:
the page management unit sorts the composed images so that the composed images are sequentially sorted based on a descending order of a number of questions per target page, so that a question target page with a highest number of questions is a first composed image.

7. The information display apparatus as claimed in claim 1,
wherein:
the question information includes priority information that denotes a priority of the question; and
the page management unit sorts the composed images so that the composed images are sequentially sorted based on the priority in a descending order of highest priority to lowest priority.

8. The information display apparatus as claimed in claim 1,
wherein:
the question information includes a display flag that denotes whether or not the question information has been displayed as the question information, and whether the question information needs to be displayed again; and
the page management unit determines the composed images whose display flag denotes that the question information has not been displayed as the question information or that the question information needs to be displayed again as the composed image intended to be displayed.

9. The information display apparatus as claimed in claim 1,
wherein:
the question information includes a questioner name display on/off information that denotes whether or not the questioner's name is displayed; and
the page management unit determines whether or not the questioner's name is displayed based on the questioner name display on/off information.

10. The information display apparatus as claimed in claim 1,
wherein:
the question information includes a question display priority information that denotes whether to make the font smaller or display a portion of the question in a case in which the question can not be fully displayed in the display area in a standard font; and
the page management unit determines a display method based on the question display priority information.

11. The information display apparatus as claimed in claim 1,
further comprising:
an input unit that inputs the question to the image displayed by the display unit with a designation of the question target page; and
a question information generating unit that generates the question information including the question and the question target page.

12. The information display apparatus as claimed in claim 11,
wherein:
the input unit inputs at least one of a priority information, a display flag, a questioner name display on/off information, and a question display priority information; and
the question information generating unit makes the question information include at least one of the priority information, the display flag, the questioner name display on/off information, and the question.

13. A question inputting apparatus, comprising:
an input unit that inputs a question to an image displayed by the display unit of the information projection apparatus as claimed in claim 1, with designating a question target page;
a question information generating unit that generates a question information including the question and the question target page; and
a communication unit that sends the question information to the information projection apparatus.

14. A system comprising:
a question inputting apparatus;
an information processing apparatus; and
an information display apparatus;
the question inputting apparatus comprising:
an input unit that inputs a question to a displayed image with a designation of a question target page;
a question information generating unit that generates the question information including the question and the question target page; and
a first communication unit that sends the question information to the information display apparatus;
the information processing apparatus comprising:
a second communication unit that receives the question information from the question inputting apparatus;
a question management unit that adds identification management information to the question information;
a question image generating unit that generates a question image based on the question information;
an operation unit that accepts a request from an external source;
a page management unit that determines a display order for displaying the question target pages based on the identification management information and sends a request for displaying a composed image that is generated by composing the question image with the display image based on a display request in response to a request for displaying the question from the operation unit; and
a third communication unit that sends a request for displaying the composed image;
the information display apparatus comprising:
a fourth communication unit that receives the request for displaying the composed image from the information processing apparatus; and
a display unit that displays the composed image.

15. The system as claimed in claim 14,
wherein:
the page management unit sorts the composed images so that the composed images are sequentially sorted based on the question target page, so that all questions from a same target page are sorted adjacently.

16. The system as claimed in claim 14,
wherein:
the page management unit sorts the composed images so that the question target page of the composed images are sequentially sorted based on the question target page, in an ascending numerical order of the question target page.

17. The system as claimed in claim 14,
wherein:
the identification management information includes a questioner identification that identifies a questioner; and
the page management unit sorts the composed images so that the composed images from a same questioner are sorted sequentially.

18. The system as claimed in claim 14,
wherein:
the page management unit sorts the composed images so that the composed images are sequentially sorted based on a descending order of a number of questions per target page, so that a question target page with a highest number of questions is a first composed image.

19. The system as claimed in claim 14,
wherein:
the question information includes priority information that denotes a priority of the question; and
the page management unit sorts the composed images so that the composed images are sequentially sorted based on the priority in a descending order of highest priority to lowest priority.

20. The system as claimed in claim 14,
wherein:
the question information includes a question display priority information that which denotes whether to make the font smaller or display a portion of the question for the in a case in which the question can not be fully displayed in the display area in a standard font; and
the page management unit determines a display method based on the question display priority information.
